(19) United States
(12) Patent Application Publication
(10) Pub. No.: US 2012/0067180 A1
(43) Pub. Date: Mar. 22, 2012

(54) TUBE MACHINING DEVICE FOR MACHINING A TUBULAR BODY

(75) Inventor: Andreas Lier, Hilzingen (DE)

(73) Assignee: ILLINOIS TOOL WORKS INC., Glenview, IL (US)

(21) Appl. No.: 13/318,720

(22) PCT Filed: May 6, 2010
(86) PCT No.: PCT/IB10/52005

§ 371 Date: Dec. 6, 2011

(30) Foreign Application Priority Data
May 6, 2009 (DE) 102009019867.9

(51) Int. Cl. B23B 5/16

(52) U.S. Cl. 82/113

(57) ABSTRACT

The invention relates to a tube machining device for machining the end of a tube, the tube machining device having an inner clamping unit with clamping wedges, which can be moved radially in relation to an axial longitudinal axis of the tube machining device relative to the tube to be machined for releasably fixing the inner clamping unit on the end region of a tube to be machined. Furthermore, a tool receiving unit for receiving a tool is provided, wherein the tool receiving unit is arranged concentrically in relation to the axial longitudinal axis and is mounted rotatably about this longitudinal axis relative to the inner clamping unit. To prevent foreign bodies from unintentionally falling into the tube to be machined and being lost there during the machining of the end of the tube, according to the invention the tube machining device also has a sealing body that can be introduced with the inner clamping unit into the end region of the tube to be machined.

The present invention relates to a pipe machining apparatus according to the preamble of patent claim 1. The invention therefore relates to a pipe machining apparatus for machining a tubular body, in particular for machining the end of a pipe, wherein the pipe machining apparatus has an internal clamping device having three clamping wedges for releasably fixing the internal clamping device to an end region of the pipe to be machined and a tool locating device for locating at least one tool provided for pipe machining. The tool locating device is in this case arranged concentrically to the axial longitudinal axis of the pipe machining apparatus in such a way that said tool locating device is rotatable about the longitudinal axis relative to the internal clamping device. To releasably fix the internal clamping device to the end region of the pipe to be machined, provision is made for the clamping wedges of the internal clamping device to be movable radially to the axial longitudinal axis of the pipe machining apparatus relative to the pipe to be machined.

Such a pipe machining apparatus is already known at least in principle from the prior art. For example, document EP 0 855 944 B1 relates to a transportable apparatus for machining the ends of tubular workpieces, such as for machining the end region of a pipe for example.

The apparatus known from this prior art has a tool locating device for locating a tool and a motor and a gearing arrangement for rotating the tool locating device about an axial longitudinal axis of the pipe machining apparatus. The tool is a cutting insert for machining the ends of pipes, this cutting insert being designed as an indexable insert and having two active cutting edges. Provided for mounting the pipe to be machined with the pipe machining apparatus is an internal clamping device which can be inserted into the end region of the pipe to be machined. The internal clamping device has three clamping wedges, by means of which the pipe is held. By means of a rotary movement of a spindle which is in operative engagement with the clamping wedges, the three clamping wedges in the interior of the pipe are turned radially outward until they come into contact with and thus fix the pipe.

Furthermore, a pipe machining apparatus which has an internal clamping device having three clamping wedges is known from document U.S. Pat. No. 5,531,550 A. The clamping wedges are radially guided in a radial guide body arranged on an actuating rod. The actuating rod including the radial guide body can be moved relative to a mast in the direction of a longitudinal axis common to the mast and the actuating rod. The mast has three sloping surfaces which extend at an acute angle to the longitudinal axis and on which the clamping wedges can be moved in a sliding manner in the axial direction, such that, during an axial movement, the clamping wedges are at the same time also moved in the radial direction and thus in the direction of an inner wall of a pipe to be clamped.

In the pipe machining apparatuses known from the prior art and described above by way of example, an internal clamping device in which the clamping wedges are connected to one another by means of springs or similar components is used as a rule, these springs also serving to hold the clamping wedges in their radial guides. Here, there is in principle the risk that the clamping wedges, for example on account of a spring fracture, will no longer be held in their radial guides and will therefore slide out of their radial guides and be lost in the pipe to be machined. This applies in particular when the internal clamping device of the pipe machining apparatus is inserted into an upwardly facing end region of a pipe to be machined, and consequently, in the event of a spring fracture, the clamping wedges which have slid out of the radial guides fall by the force of gravity into the pipe to be machined.

During the machining of pipe ends of an already finished plant, such as, for example, of a boiler or a chemical plant, foreign bodies which have been lost in the pipe to be machined can often only be removed again at a high cost, since such plants as a rule cannot be opened or cannot be readily opened in order to remove any foreign bodies.

Even in a pipe machining apparatus in which, for example on account of a design modification of the internal clamping device, the clamping wedges can be effectively prevented from falling out, there is in principle the risk that foreign bodies, such as, for example, the chips which accumulate during machining of the pipe end, will fall into the pipe to be machined, and accordingly said chips then have to be removed again after the machining of the pipe end.

On the basis of this statement of the problem, the object of the present invention is to develop a pipe machining apparatus of the type mentioned at the beginning to the effect that foreign bodies can be effectively prevented from falling into the pipe during the machining of the pipe in a manner which is easy to realize but is nonetheless effective.

With a pipe machining apparatus of the type mentioned at the beginning, this object is achieved according to the invention in that a sealing body which can be inserted with the internal clamping device into the end region of the pipe to be machined is provided in order to spatially subdivide the pipe to be machined into a region facing the tool locating device and a region remote from the tool locating device.

Advantageous developments of the pipe machining apparatus according to the invention are specified in the dependent claims.

The advantages which can be achieved with the solution according to the invention are obvious: by the provision of a sealing body which can be inserted together with the internal clamping device into the end region of the pipe to be machined, the pipe can be spatially subdivided into a first region facing the tool locating device and a second region remote from the tool locating device before the start of the machining. This spatial subdivision serves to seal the second region remote from the tool locating device relative to the first region facing the tool locating device, and therefore no foreign bodies can pass unintentionally from the first region into the second region.

Since the second region of the pipe formed with the sealing body inserted into the end region of the pipe is further away from the pipe end to be machined than the first region of the pipe, foreign bodies, such as, for example, clamping wedges released on account of a defect of the internal clamping device or else also the chips accumulating during machining, can be effectively prevented from falling into and being lost in the pipe to be machined.

After the machining of the pipe, the internal clamping device can be pulled together with the sealing body out of the end region of the pipe, foreign bodies which have possibly fallen into the pipe being removed again from the pipe when the sealing body is brought out.

It is conceivable in principle for the sealing body, in the inserted state, to be arranged between the internal clamping device arranged inside the pipe to be machined and the tool locating device provided outside the pipe adjacent to the pipe end in order to be able to effectively prevent the accumulating chips from being lost in the pipe, for example during a machining operation. It is especially preferred, however, to provide the sealing body not only in the longitudinal direction of the pipe machining apparatus behind the tool locating device but also behind the internal clamping device. This is because the internal clamping device is located with the axially displaceable clamping wedges belonging to the internal clamping device in the first region spatially subdivided by the sealing body when the into the clamping device is inserted together with the sealing body into the end region of the pipe to be machined. Therefore, in the first region facing the tool locating device, not only the chips accumulating, for example, during a machining operation but also, for example, the clamping wedges falling out on account of a defect of the internal clamping device can be caught and removed without any difficulties.

In a preferred realization of the pipe machining apparatus according to the invention, the internal clamping device and the sealing body are fastened to an actuating rod movable in the axial longitudinal direction relative to the tool locating device. This concerns an effective but nonetheless easy-to-realize possibility with which, without additional effort, the sealing body can also be inserted together with the internal clamping device into the end region of the pipe to be machined. However, it is of course also conceivable in principle for the sealing body to be inserted independently of the internal clamping device into the end region of the pipe to be machined.

The solution according to the invention is distinguished not only by the fact that foreign bodies can be effectively prevented by the provision of the sealing body from falling into and being lost in the pipe to be machined. In particular if the internal clamping device is arranged between the sealing body and the tool locating device, such that first of all the sealing body and then the internal clamping device have to be inserted into the end region of the pipe for connecting the pipe machining apparatus to the pipe to be machined, the sealing body has an additional guidance function, such that the insertion of the internal clamping device into the end region of the pipe is simplified. In particular, the individual components of the internal clamping device, such as, for instance, the clamping wedges or spring elements possibly provided for connecting the clamping wedges, can be effectively prevented upon insertion of the internal clamping device from striking the encircling edge of the end region of the pipe to be machined and from possibly being damaged.

In order to be able to effectively prevent foreign bodies from possibly falling into the end region of the pipe and being lost, for example during or for preparing for the machining of the pipe end, the sealing body should preferably be designed in such a way that it bears, at least in certain regions, in a positive-locking manner against the inner wall of the pipe, to be machined, in the state in which it is inserted in the end region of the pipe to be machined. In this way, unintentional transfer of foreign bodies from the first region facing the tool locating device into the second region remote from the tool locating device can be prevented or at least limited.

In this case, it is for example conceivable for the sealing body to have at least one sealing element which is designed as a brush seal and which, in the state in which the sealing body is inserted in the end region of the pipe to be machined, with regard to unintentional transfer of foreign bodies, seals a gap between the sealing body and the inner wall of the pipe to be machined. The provision of such a brush seal not only has the advantage that transfer of foreign bodies from the first region, formed by means of the sealing body, of the pipe to machined to the second region of the pipe to be machined are prevented in a manner which is easy to realize but is nonetheless effective, but also has the advantage that the pipe machining apparatus with the sealing body which can be inserted in the end region of the pipe to be machined is suitable for machining pipe ends of different cross-sectional diameters.

The brush complement of the brush seal should therefore preferably project radially from the sealing body and have a density which is adapted to the average grain size of the foreign bodies to be expected. The length of the individual bristles of the brush seal in the axial direction determines the region in which the pipe machining apparatus is suitable with one and the same sealing body for machining the ends of pipes of different cross-sectional diameters.

In principle, it is preferred if the sealing body is releasably fastened to the pipe machining apparatus in order to be able to exchange the sealing body as quickly as possible, if necessary. For example, it is conceivable to fasten the sealing body to the end face of an actuating rod which can be moved in the axial longitudinal direction relative to the tool locating device, a nut screwed onto the end of the actuating rod being used for this purpose. However, other possibilities for the preferably releasable fastening of the sealing body to the pipe machining apparatus are of course also suitable.

As an alternative to or in addition to the already discussed embodiment of the sealing body in which at least one sealing element designed as a brush seal is provided, it is also conceivable for the sealing body to have at least one sealing element which is designed as a lip seal and which, in the state in which the sealing body is inserted in the end region of the pipe to be machined, seals a gap between the sealing body and the inner wall of the pipe to be machined. The advantages which can be achieved by the provision of a sealing element designed as a lip seal are comparable with the advantages which occur in the case of a sealing element designed as a brush seal, and therefore reference is made to the previous comments in order to avoid repetitions.

In a further advantageous realization of the sealing body, it is in principle conceivable for said sealing body to be formed from an elastic material and for it to be elastically deformable with the cross-sectional area being reduced. A suitable material for the sealing body is therefore an elastic foam material, such as, for instance, polyurethane. Depending on the application, however, the sealing body and the sealing element possibly belonging to the sealing body should be heat-resistant, since the end region of the pipe accordingly heats up during the machining of the pipe. Suitable heat-resistant sealing bodies are generally known from the prior art and are not described in any more detail herein.

As already indicated, it is preferred if the sealing body is arranged in front of the internal clamping device and is therefore the first component inserted into the end region of the pipe when fastening the pipe machining apparatus to the pipe to be machined. In order to simplify the insertion of the sealing body into the pipe end region, it is in principle conceivable for the sealing body to have a narrowing, in particular conical, longitudinal section geometry, wherein the narrowed end region of the sealing body points in a direction opposed to the tool locating device. The sealing body is therefore inserted over its narrowed end region into the pipe to be machined, such that self-adjustment takes place.

Furthermore, it is preferred if the sealing body has at least one guide surface which extends parallel to the axial longitudinal direction of the pipe machining apparatus and by means of which the sealing body is guided along the inner wall of the pipe during the insertion operation. This concerns a preferred development which simplifies the fastening of the pipe machining apparatus to the pipe to be machined.

The invention is described below with reference to the attached drawings and with the aid of an exemplary embodiment of the pipe machining apparatus according to the invention.

In the drawing:

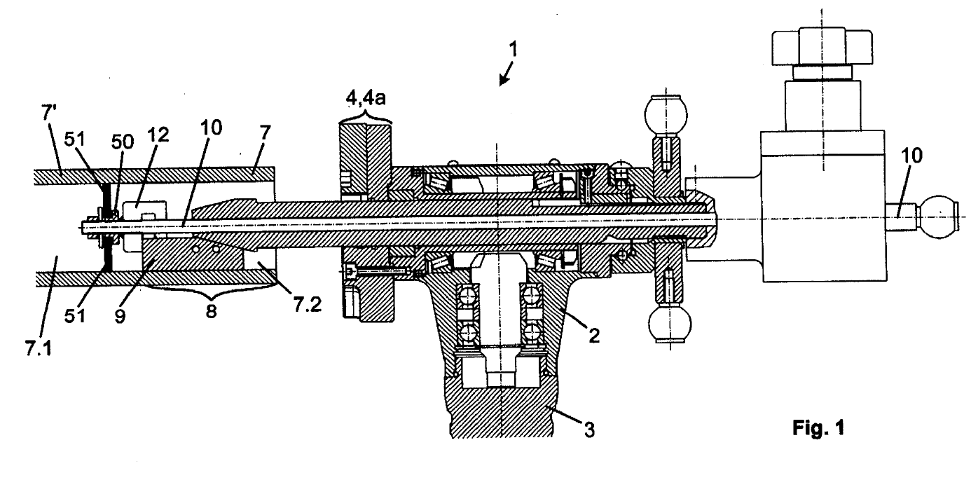

FIG. 1 shows a partly sectioned side view of an exemplary embodiment of the pipe machining apparatus according to the invention, the pipe machining apparatus being fastened to the end region of a pipe to be machined;

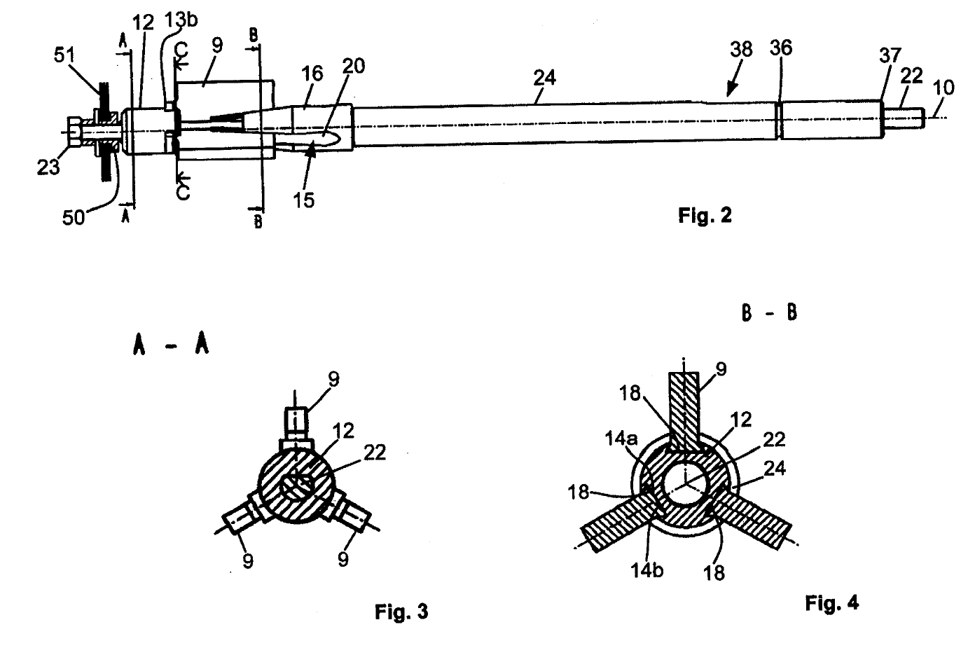

FIG. 2 shows parts of the internal clamping device used in the exemplary embodiment of the pipe machining apparatus according to the invention shown in FIG. 1;

FIG. 3 shows a section along axis A-A in FIG. 2;

FIG. 4 shows a section along axis B-B in FIG. 2;

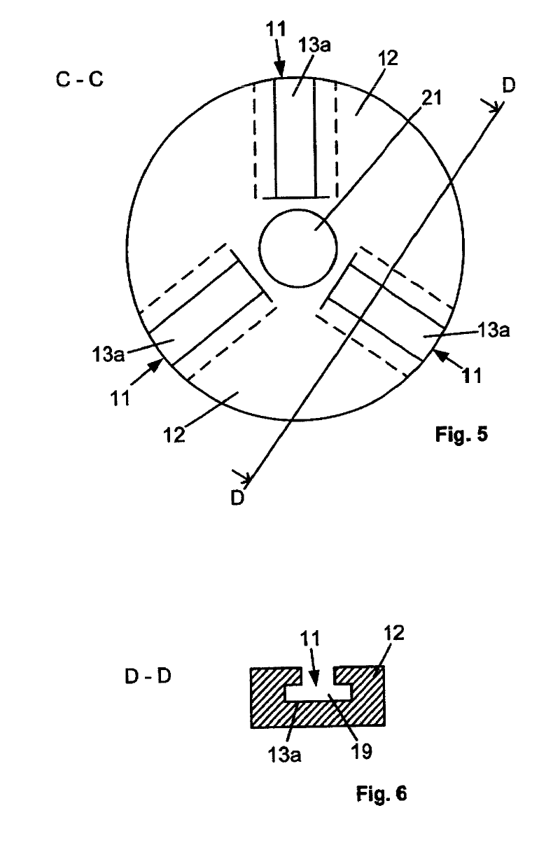

FIG. 5 shows a section along axis C-C in FIG. 2, although the clamping wedges have not been shown for the sake of clarity;

FIG. 6 shows a section along axis D-D in FIG. 5; and

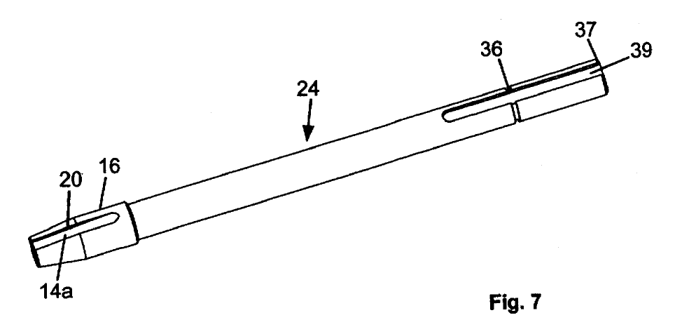

FIG. 7 shows a mast of the internal clamping device according to FIG. 2 in a perspective illustration.

Shown in the attached figures is an exemplary embodiment of the pipe machining apparatus 1 according to the invention, which as shown in the illustration in FIG. 1 has a housing 2 and a handle 3. A tool carrier, not explicitly shown in FIG. 1, is arranged or located in a tool locating device 4 and serves to carry a tool, for example in the form of a cutting insert (indexable insert). The cutting insert (not shown in FIG. 1) serves, for example, to bevel that end of a pipe 7 which faces the pipe machining apparatus 1 or the tool carrier, i.e. to provide said end with a chamfer, and thus to prepare it for a welding process.

Alternatively, or in addition, however, the use of other tools for machining pipe ends, such as, for example, grinding tools or tools for deburring or facing, is also conceivable, but in particular the use of tools for machining a pipe on an inner and/or outer side, for example a threading tool for cutting threads on the pipe inner and/or outer side or a turning tool for turning the pipe outer and/or inner side.

For locating, for example, a second and a third tool carrier which hold either the same tools or else also other tools for simultaneously carrying out a plurality of operations, further tool carrier receptacles can be arranged on the tool locating device 4 in addition to the tool carrier receptacle 4a. The tool locating device 4 together with the tool carrier and the cutting insert held by the tool carrier is arranged concentrically to an axial longitudinal axis 10 of the pipe machining apparatus 1 and so as to be rotatable about this longitudinal axis 10.

To reliably fix the pipe 7 before or during planned machining, the pipe machining apparatus 1 according to the invention has an internal clamping device 8 having three clamping wedges 9 which can be inserted into the pipe 7. The three clamping wedges 9 each consist of a metal plate, the plane of which in each case extends radially and axially relative to the longitudinal axis 10.

The wedges 9 are radially guided by radial guide surfaces 13a of a radial guide body 12 and are guided obliquely by sloping guide surfaces 14a, extending at an acute angle to the longitudinal axis, of a sloping guide body 16, wherein the radial guide body 12 is movable relative to the sloping guide body 16 axially to the longitudinal axis 10, such that the clamping wedges 9 are moved, such as to remain parallel to one another, in the longitudinal direction and at the same time radially in the process. The radial guide surfaces 13a of the radial guide body 12 and the radial guide surfaces 13b of the clamping wedges 9 engage one behind the other transversely to the radial direction, such that the clamping wedges 9 are held on the radial guide body 12 in the axial direction. The sloping guide surfaces 14a of the sloping guide body 16 and the sloping guide surfaces 14b, guided by them, of the clamping wedges 9 engage one behind the other transversely to the sloping direction, such that the clamping wedges 9 are held on the sloping guide body 16 transversely to the sloping direction.

The radial guide surfaces 13a, 13b form a respective T-shaped radial guide 11 (cf., e.g., FIG. 6) for each clamping wedge 9. Each T-shaped radial guide 11 has a T-shaped guide groove 19 in the radial guide body 12 and a matching T-shaped guide head 17 on the relevant clamping wedge 9.

Furthermore, the sloping guide surfaces 14a, 14b form a respective dovetailed sloping guide 15 for each clamping wedge 9. Each dovetailed sloping guide 15 has a dovetail guide groove 20 in the sloping guide body 16 and a matching dovetail guide head 18 on the relevant clamping wedge 9. The advantage of a design of the sloping guide 15 as a dovetail guide is the small overall radial height of the same, and therefore the preferred embodiment of the pipe machining apparatus 1 according to the invention is also suitable for pipes 7 of small diameter.

In the preferred embodiment, both the radial guide 11 and the sloping guide 15 have undercut guide grooves 19, 20 and matching guide heads 17, 18. As an alternative to a design in which the respective guide grooves 19, 20 are assigned to the radial guide body 12 and the sloping guide body 16 and the corresponding guide heads 17, 18 are assigned to the clamping wedges 9, a design in which the respective guide grooves 19, 10 are arranged on the clamping wedges 9, whereas the radial guide body 19 and the sloping guide body 16 have the corresponding guide heads 17, 18, is also conceivable. Any other desired combinations (e.g. providing the guide head 17 of the radial guide 11 and the guide groove 20 of the sloping guide 15 on the clamping wedge 9 and the respectively corresponding components on the radial guide body 12 and on the sloping guide body 16, respectively) are also conceivable. In addition to a T-shaped guide and a dovetail guide, other guides, such as, for example, flat guides, Vee-guides or cylindrical guides, are also suitable, each of said guides being conceivable as both a radial guide and a sloping guide.

In the preferred embodiment described here, the radial guide body 12 is of cylindrical design and has a through-hole 21 in the center. The radial guide body 12 is fastened to an actuating rod 22 movable in the axial longitudinal direction, i.e. in the direction of the longitudinal axis 10. In the preferred embodiment, the fastening is effected by means of a fastening device in the form of a nut 23. To this end, the fastening rod 22 has a thread which is arranged on its end facing the pipe. Any other fastening or frictional arrangement would of course also be possible, for example by means of a bolt or cotter pin, or else also by means of an interference fit.

At its end remote from the tool locating device 4, the through-hole 21 of the radial guide body 12 has a section (extending along the longitudinal axis 10) with a non-circular cross-sectional shape. The actuating rod 22 has a section which corresponds thereto and which has a non-circular cross-sectional shape of matching size. This design ensures that the radial guide body 12 is non-rotatably mounted on the actuating rod 22, i.e. that the radial guide body 12 cannot rotate relative to the actuating rod 22. In the preferred embodiment described, the non-circular cross section is designed as a section of the actuating rod 22 which is flattened at the circumferential lateral surface. The radial guide body 12 has a configuration corresponding thereto. Furthermore, a step which is formed on the actuating rod 22 and, in a corresponding manner thereto, on the radial guide body 12 ensures that the radial guide body 12 is in a fixed position on the actuating rod 22 in the longitudinal direction.

In the embodiment described, the sloping guide body 16 is formed integrally with a hollow mast 24. Alternatively, the sloping guide body 16 could also be arranged as an independent element on the mast 24; in particular, it can be fastened thereto (for example by an external thread which is formed on the mast 24 and which corresponds to an internal thread formed on the sloping guide body 16, or else also by adhesive bonding, brazing, welding or also, for example, by a headless screw).

The mast 24 is movably arranged relative to the tool locating device 4 (and to the housing 2) with respect to the axial longitudinal axis 10. The actuating rod 22 is arranged in the mast 24 so as to be movable or displaceable relative to said mast 24 and likewise relative to the tool locating device 4 along the longitudinal axis 10. Thus, on the one hand, the actuating rod 22 can be moved axially relative to the mast 24 and, on the other hand, the mast 24 can be moved in the axial longitudinal direction relative to the tool locating device 4 or relative to the tool carrier.

The relative mobility between mast 24 and actuating rod 22 ensures that the clamping wedges 9, which are radially guided in the radial guide body 12 fastened to the actuating rod 22, can be moved axially along the sloping guide surfaces 14a which are arranged on the mast 24 and are to be assigned to the sloping guide body 16. The result of this is that, during a movement of the actuating rod 22 relative to the mast 24 along the axial longitudinal axis 10 out of the pipe 7, the clamping wedges 9 are displaced radially outward and approach the inner wall of the pipe 7. During a relative movement in the opposite direction, the clamping wedges 9 move away from the inner wall of the pipe 7.

The pipe 7 is therefore clamped or fixed before the planned machining by the actuating rod 22 being moved along the axial longitudinal axis 10 in a direction from the clamping wedges 9 toward the housing 2 (the mast 24 remains in a fixed position in the process) until the clamping wedges 9 bear against the inner wall of the pipe 7 and hold the latter fixedly in its position. The actuating rod 22 is then fixed in its position by means of a handle.

In addition to the manual operation or actuation of the clamping wedges 9 which is described above by way of example, actuation of the clamping wedges 9 or of the actuating rod 22 in another way by means of an electric (electric-motor-driven), hydraulic or also pneumatic actuating and/or locking device is of course also possible. All combinations of the modes of operation are also conceivable, and so the actuating rod 22, for example, can be actuated pneumatically, while the fixing is effected manually or electrically. For example, hydraulic actuation of the actuating rod 22 with pneumatic fixing of the position thereof would also be conceivable.

Once the pipe 7 has been fixed, machining of the same can be started. In the process, the relative mobility between the tool locating device 4 (including housing 2 and handle 3) and the mast 24 ensures that the tool locating device 4 together with the tool carrier and the cutting insert can be moved relative to the pipe 7 along the axial longitudinal axis 10 and thus a feed of the tool in the direction of the pipe 7 or into the pipe 7 and an opposite movement are possible. For the machining, the tool locating device 4 is set in rotation relative to the pipe 7 and relative to the housing 2 by means of an electric motor (not shown) via a gear unit (likewise not shown), said electric motor being located in the housing 2 and being placed in the region of the handle 3, such that the tool locating device 4 together with tool carrier 5 and cutting insert 6 rotates about the axial longitudinal axis 10.

The requisite tool feed is achieved via a feed device which moves or feeds forward the housing 2 together with tool locating device 4 plus tool carrier and cutting insert along the axial longitudinal axis 10 toward the pipe 7.

The feed cap sleeve has an internal thread which is in engagement with a corresponding external thread provided on the mast 24. The external thread on the mast 24 extends in this case from a thread root clearance 36 up to the end 37 of the mast 24 (cf. in this respect, e.g., FIG. 7, from which the thread root clearance 36 can be seen; the thread itself cannot be seen from this figure). The housing 2 together with the tool locating device 4, the tool carrier 5 and the cutting insert is fed forward on the mast 24 in the direction of pipe 7 by a rotary movement (clockwise rotation) of the feed cap sleeve. In order to ensure the rotatability of the feed cap sleeve relative to the housing 2, said feed cap sleeve runs on balls 38 arranged between the housing 2 and the feed cap sleeve (in recesses in each case provided for this purpose in the feed cap sleeve and in the housing 2). In order to prevent rotation of the mast 24 in the housing, said mast 24 (cf. in this respect FIG. 7) has a mating keyseat 39 extending along the axial longitudinal axis 10. The anti-rotation locking is achieved in this case by means of a headless screw in operative engagement with a feather key (not shown). As an alternative to the feed device described above, all other feed devices, for example on a pneumatic, hydraulic or else electric-motor-driven basis, are

As can be seen from the illustration in FIG. 1, a sealing body 50 having a sealing element 51 designed as a brush seal is provided on the front end of the pipe machining apparatus. In particular, the sealing body 50 is releasably fastened together with the actuating rod 22 movable in the axial longitudinal direction 10 relative to the tool locating device 4. Used for this purpose is a nut or screw 23, which is only schematically shown in FIG. 1 and which is screwed onto the front end of the actuating rod 22.

As shown in FIG. 1, the sealing body 50 together with the sealing element 51 designed as a brush seal is embodied in such a way that the sealing body 50 bears in a positive-locking manner against the inner wall of the pipe 7, to be machined, in the state in which it is inserted in the end region 7′ of the pipe 7 to be machined. In this way, the pipe 7 to be machined is subdivided into a first region 7.1 facing the tool locating device 4 and a second region 7.2 remote from the tool locating device 4.

In the exemplary embodiment of the pipe machining apparatus according to the invention, as shown, for example, in FIG. 1, provision is made for the internal clamping device 8 and the actuating rod 22 movable in the axial longitudinal direction 10 relative to the tool locating device 4 to be fastened together with the sealing body 50. In particular, the internal clamping device 8 is arranged between the sealing body 50 and the tool locating device 4 and therefore lies in the first region 7.1 subdivided by the sealing body 50. The chips which accumulate in particular during the machining and which fall into the pipe 7 are prevented from penetrating into the rear region of the pipe (second region 7.2) to be machined and from possibly being lost, on account of the provision of the sealing body, which in the exemplary embodiment is provided with a sealing element 51 designed as a brush seal. To this end, it is preferred if the sealing element 51 designed as a brush seal, in the state in which the sealing body 50 is inserted in the end region 7′ of the pipe 7 to be machined, seals a gap S between the sealing body 50 and the inner wall of the pipe 7 to be machined.

The invention is not restricted to the exemplary embodiment of the pipe machining apparatus 1 described above with reference to the drawings. On the contrary, all the features disclosed in the application documents can be realized individually or in combination in the pipe machining apparatus.

In particular, it is conceivable for the sealing body 50, in addition to or as an alternative to the sealing element 51 designed as a brush seal, to have a sealing element 51′ which is designed as a lip seal and which, in the state in which the sealing body 50 is inserted in the end region 7′ of the pipe 7 to be machined, seals the gap S between the sealing body 50 and the inner wall of the pipe 7 to be machined.

At the same time, it is conceivable for the sealing body 50 to be formed from an elastic material which can be deformed elastically with the cross-sectional area being reduced, and therefore it can be ensured that, on the one hand, the sealing body can be effortlessly inserted into the end region of the pipe to be machined and that, on the other hand, the sealing body bears in a positive-locking manner against the inner wall of the pipe, to be machined, in the state in which it is inserted in the end region 7′ of the pipe 7 to be machined and transfer of foreign bodies between the first and the second region is prevented.

On the other hand, it is also conceivable to embody the sealing body 50 without sealing elements, for example in the form of a brush seal or a lip seal.

In particular, it is preferred in this case if the sealing body 50 has a narrowing, in particular conically tapering, longitudinal section geometry, in which the narrowed end region of the sealing body 50 points away from the tool locating device 4. As a result of this narrowing shape of the sealing body, said sealing body has a self-centering function which simplifies the insertion of the sealing body into the end region of the pipe to be machined.

Alternatively or additionally, it is also conceivable for the sealing body 50 to have at least one guide surface extending parallel to the axial longitudinal direction 10 of the pipe machining apparatus 1 in order to be able to guide the sealing body 50 along the inner wall of the pipe 7 during the insertion operation.

1. Pipe machining apparatus for machining a tubular body, in particular for machining the end of a pipe, wherein the pipe machining apparatus has the following:
an internal clamping device which is designed so as to be suitable for inserting into an end region of a pipe to be machined and has at least three clamping wedges which can be moved radially to an axial longitudinal axis of the pipe machining apparatus relative to the pipe to be machined for releasably fixing the internal clamping device on the end region of the pipe to be machined; and
a tool locating device for locating at least one tool provided for pipe machining, wherein the tool locating device is arranged concentrically to the axial longitudinal axis of the pipe machining apparatus and so as to be rotatable about this longitudinal axis relative to the internal clamping device,
characterized in that
the pipe machining apparatus furthermore has a sealing body which can be inserted with the internal clamping device into the end region of the pipe to be machined and which is intended for spatially subdividing the pipe to be machined into a region facing the tool locating device and a region remote from the tool locating device.

2. Pipe machining apparatus according to claim 1, wherein the sealing body is designed for bearing in a positive-locking manner against the inner wall of the pipe, to be machined, in the state in which it is inserted in the end region of the pipe to be machined.

3. Pipe machining apparatus according to claim 1, in particular according to claim 2, wherein the sealing body has at least one sealing element which is designed as a brush seal and which, in the state in which the sealing body is inserted in the end region of the pipe to be machined, seals a gap between the sealing body and the inner wall of the pipe to be machined.

4. Pipe machining apparatus according to claim 2, wherein the sealing body has at least one sealing element which is designed as a lip seal and which, in the state in which the sealing body is inserted in the end region of the pipe to be machined, seals a gap between the sealing body and the inner wall of the pipe to be machined.

5. Pipe machining apparatus according to claim 2, wherein the sealing body is formed from an elastic material and can be deformed elastically with the cross-sectional area being reduced.

6. Pipe machining apparatus according to claim 5, wherein the sealing body has a narrowing, in particular conically narrowing, longitudinal section geometry, wherein the narrowed end region of the sealing body points in a direction opposed to the tool locating device.

7. Pipe machining apparatus according to claim 1, wherein the sealing body has at least one guide surface which extends parallel to the axial longitudinal direction of the pipe machining apparatus and is intended for guiding the sealing body along the inner wall of the pipe during the insertion operation.

8. Pipe machining apparatus according to claim 1, wherein the internal clamping device is arranged between the sealing body and the tool locating device.

9. Pipe machining apparatus according to claim 8, wherein the internal clamping device and the sealing body are fastened to an actuating rod movable in the axial longitudinal direction relative to the tool locating device.

10. Pipe machining apparatus according to claim 1, wherein the clamping wedges are radially guided by radial guide surfaces of a radial guide body and are guided obliquely by sloping guide surfaces, extending at an acute angle to the longitudinal axis, of a sloping guide body, and wherein the radial guide body is movable relative to the sloping guide body axially to the longitudinal axis of the pipe machining apparatus, such that the clamping wedges are moved, such as to remain parallel to one another, in the longitudinal direction and at the same time radially in the process.

11. Pipe machining apparatus according to claim 10, wherein the radial guide surfaces of the radial guide body and the radial guide surfaces of the clamping wedges engage one behind the other transversely to the radial direction, such that the clamping wedges are held on the radial guide body in the axial direction.

12. Pipe machining apparatus according to claim 10, wherein the radial guide body is fastened to the actuating rod movable in the axial longitudinal direction relative to the tool locating device.

13. Pipe machining apparatus according to claim 10, wherein the sloping guide surfaces form a respective dovetailed sloping guide for each clamping wedge.
